(19) United States
(12) Patent Application Publication
(10) Pub. No.: US 2006/0213553 A1
(43) Pub. Date: Sep. 28, 2006

(54) Low profile overfill limit device with reverse flow capability

(75) Inventors: Vaughn K. Mills, Chelsea, MI (US); Kenneth M. Spink, Jerome, MI (US)

Correspondence Address: EATON CORPORATION;EATON CENTER, 1111 SUPERIOR AVENUE, CLEVELAND, OH, 44114, US

(73) Assignee: VAUGHN K. MILLS & KENNETH M. SPINK

(21) Appl. No.: 11/086,690

(22) Filed: Mar. 22, 2005

(51) Int. Cl. B60K 15/035

(52) U.S. Cl. 137/43

(57) ABSTRACT

A compact overflow limiting vapor vent/tipping valve assembly with pressure and vacuum relief. A float operated vapor vent/tipping valve may be either attached to a cap with a vapor outlet port which is welded over an access opening in the tank or, the valve may have a valve body formed integrally as one piece with a portion of the tank wall structure. The vapor vent/tipping valve includes therein a gravity operated pressure relief valve for preventing vapor venting below a threshold pressure; and, the pressure relief valve includes a vacuum relief valve permitting reverse flow to admit make up air in the event of sub-atmospheric pressure in the fuel tank.

### BACKGROUND

Small engines, as they are often referred to, are widely considered to be engines of less than approximately 50 horsepower (37.2 kilowatts) and are employed for applications such as lawn mowers, garden tractors, portable generating sets and certain marine applications. Small engines for such applications typically have the fuel tank mounted proximate the engine for ease of installation of the engine on the appliance. Such small engine applications generally have a tank disposed for gravity fuel feed to the engine carburetor; however, in certain specialized applications with engines approaching 50 h.p. fuel pumps may be employed.

Small engine fuel tanks generally have a user removable filler cap or closure which has formed therein a vent passage for permitting make up air to enter the tank as fuel is withdrawn during engine operation to prevent vacuum formation therein and subsequent collapse of the tank.

Fuel vapor emissions restrictions or limitations previously were only required for motor vehicles but have recently been mandated for small engines. Previously, because no such limitations were required for small engines, the fuel tank and fuel system were free to emit fuel vapors to the atmosphere both during engine operation and during periods of engine shut down.

Small engines are manufactured in very high volumes in mass production; and, the tooling for the fuel tanks and fuel system and mounting of the tank and the fuel system components on the engines has been a significant expense for the manufacturer of the engines. Furthermore in a significant number of applications for small engines, the space or volume allotted for the engine and fuel tank is highly restricted; and, adding components to the engine and tank, or requiring tank redesign is prohibitively costly.

Accordingly, it has been desired to provide a way or means of limiting fuel vapor emission on small engines without requiring redesign of the fuel tank and related fuel system components or the addition of components which would add volume to the envelope of the engine and fuel tank thereby complicating installation and increasing manufacturing costs of such small engines in the appliances in which they are employed.

### SUMMARY

The present specification, drawings and claims present a solution to the above described problem of providing fuel vapor emission control for small engines wherein a low profile overfill limiting vapor vent/tipping valve assembly with pressure and vacuum relief is provided with a compact design and adapted for attachment to an access opening through the wall of an existing fuel tank structure. In one embodiment, the valve assembly described herein utilizes a cap with a vapor outlet port therein and which is formed of material weldable to the tank wall with the overflow limiting vapor vent/tipping valve attached to the cap to form a sub assembly. The cap is then disposed over the access opening in the tank wall and welded to the surface of the tank wall.* The valve assembly includes a pressure relief valve permitting the vapor above a predetermined pressure to escape through the cap vent outlet; and, the valve assembly also includes a vacuum relief valve to permit reverse flow in the event of formation of a vacuum in the fuel tank to prevent collapse of the tank. The presently described valve assembly thus enables the provision of the necessary functions to retain and limit the escape of fuel vapor from the tank to the atmosphere yet permits flow of vapor under engine operation from the valve outlet which is adapted for connection to either a vapor storage device or the engine air inlet.
In another embodiment, the valve body is formed integrally as one piece with the upper portion of the fuel tank wall structure.

### BRIEF DESCRIPTION OF THE DRAWINGS

FIG. 1 is a cross section of a small engine fuel tank with the valve assembly described herein mounted through an access opening;

FIG. 2 is an enlarged view of the valve body subassembly of FIG. 1; and

FIG. 3 is an exploded view of the subassembly of FIG. 2; and,

FIG. 4 is a cross section of a small engine fuel tank illustrating another embodiment.

### DETAILED DESCRIPTION

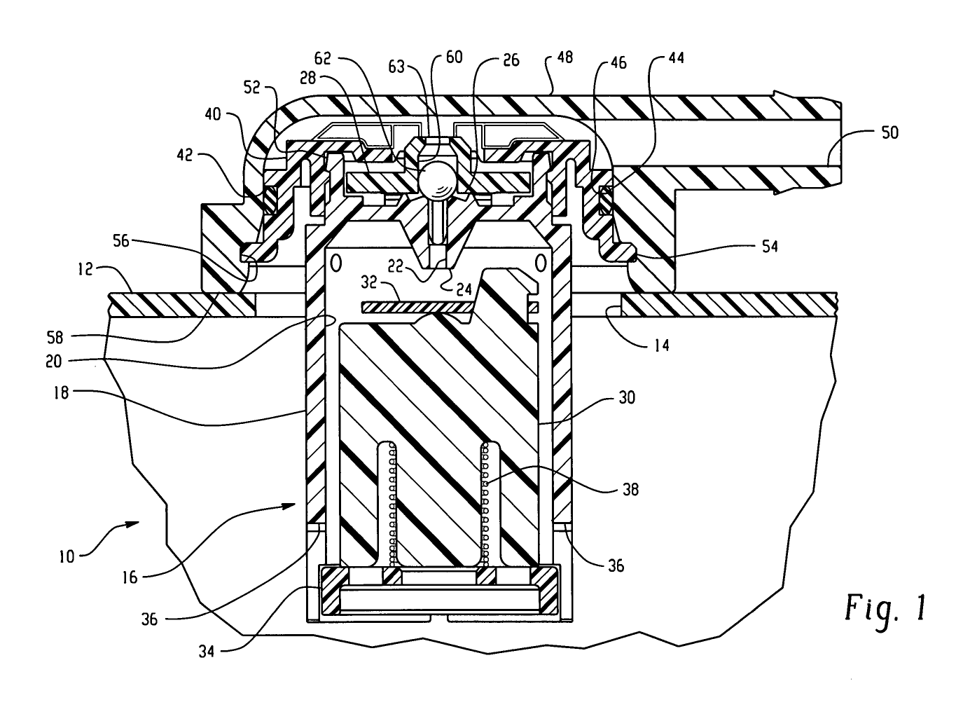

Referring to FIG. 1, a portion of a small engine fuel tank is indicated generally at 10 and has the upper wall structure 12 formed with an access opening 14 therein with an overfill limiting vapor vent/tipping valve assembly indicated generally at 16 disposed with the body 18 thereof extending downwardly through the access only into the interior of the tank.

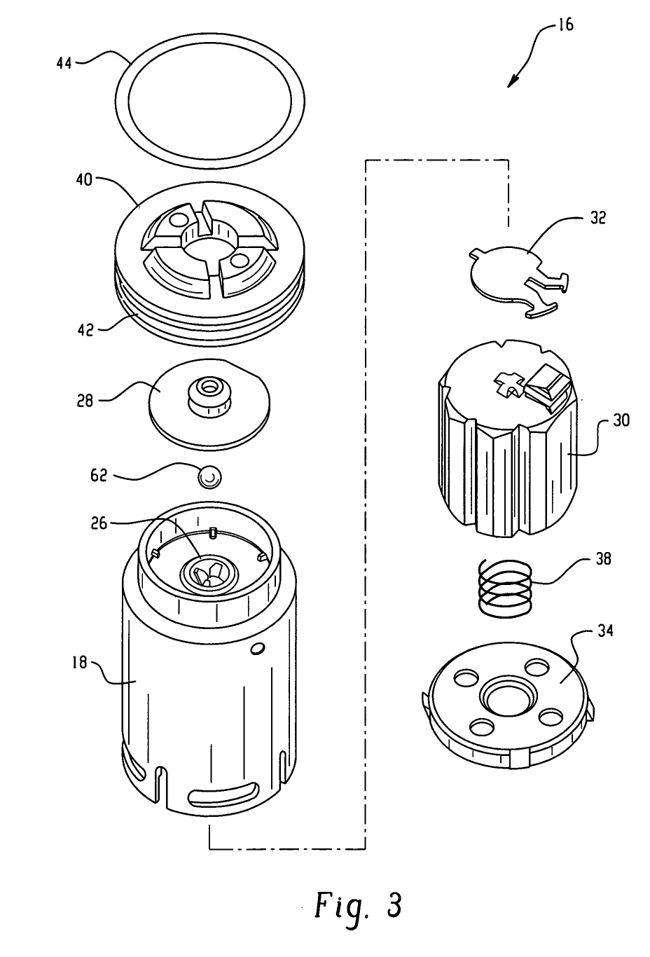

Referring to FIGS. 1-3, the valve body 18 has a valving chamber 20 formed therein which communicates through a vent passage 22 which may be vertically oriented with a valve seat 24 formed at the lower end thereof. The upper end of passage 22 has a second valve seat 26 formed thereabout with a valving member 28 seated thereon; and, in the present practice the valve member 28 is formed of a material such as metal to rest against the valve seat 26 under the influence of gravitational forces. The weight of member 28 and the diameter of valve seat 26 are chosen such that when a predetermined pressure exists in the valving chamber 20, valve 28 is lifted off of the seat 26 and vapor flows through passage 22.

Valving chamber 20 has disposed therein a float 30 with a flexible valve member such as strip 32 which may be formed of elastomeric material disposed on the upper surface thereof. Upon the float 30 rising to a predetermined fuel level in the tank, member 32 closes upon valve seat 24 preventing vapor from entering the passage 22. Float 30 is retained in valving chamber 20 by a retaining ring 34; and, suitable passages 36 are formed in the valve body to admit liquid fuel into the valving chamber 20. In the present practice, it has been found satisfactory to facilitate the movement of the float with an additional bias spring 38 between the float and the retaining member 34, which may be calibrated for moving the float in the direction of buoyancy to close valve member 32 on seat 24 at a desired level of fuel in the tank and at a predetermined tilt angle.

The valve body 18 is attached to an upper body portion or insert 40 which may have a generally inverted cup shape with an annular groove 42 formed about the outer periphery thereof, which groove has received therein a sealing ring such as an o-ring 44 which seals about the inner wall 46 of a cap 48 which has an outlet or vapor purge passage 50 formed therein.

The body 18 is attached to the insert 40 by any suitable mechanical expedient, such as snap locking tabs 52. It will be understood that the valve body may be formed of material not weldable to the tank for structural integrity; however, the cap 48 is formed of material weldable to the tank such as by sonic or spin welding to form a sub assembly including the valve member 28 and cap 48. The sub assembly is retained in the cap by any suitable mechanical expedient such as interference fit or snap locking of annular flange 54 into a groove 56 formed in the cap. Alternatively, insert 40 may be formed of material weldable to cap 48 and secured thereto by weldment. The rim 58 of the cap with the valve assembled therein may then be secured to the surface of the tank wall 12 by any suitable expedient such as weldment.

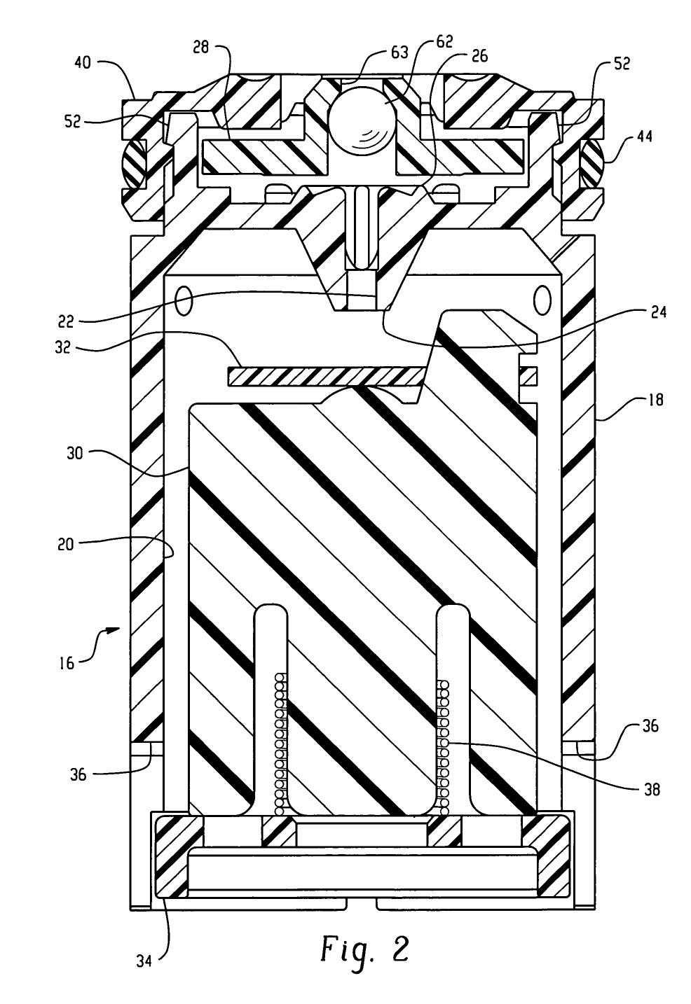

The gravity responsive valve member 28 has a valving chamber 60 formed therein with a vertically oriented flow passage 63 formed in the upper end thereof which passage communicates with the interior of the cap 48 and the purge outlet 50. Valving chamber 60 has received therein a feather light valve member 62 which, upon the slightest vapor pressure through passage 22 is moved to the position shown in FIG. 2 to close passage 63; and thereafter valve member 62 maintains the passage 63 closed. Thereafter, as the pressure in the passage 22 rises the gravity valve number 28 is caused to be moved to the upward limit position shown in FIG. 2 and vapor flow therearound is permitted to the purge outlet passage 50.

In the event of sub-atmospheric pressure in the chamber 20, the valve member 62 is caused to move downwardly opening passage 63 and permitting reverse flow into passage 50 and into the fuel tank. Thus, valve 62 permits make up air to enter the fuel tank as liquid fuel is withdrawn during engine operation; or, in the event of cooling of the vapor and formation of a vacuum in the tank while the engine is shut down.

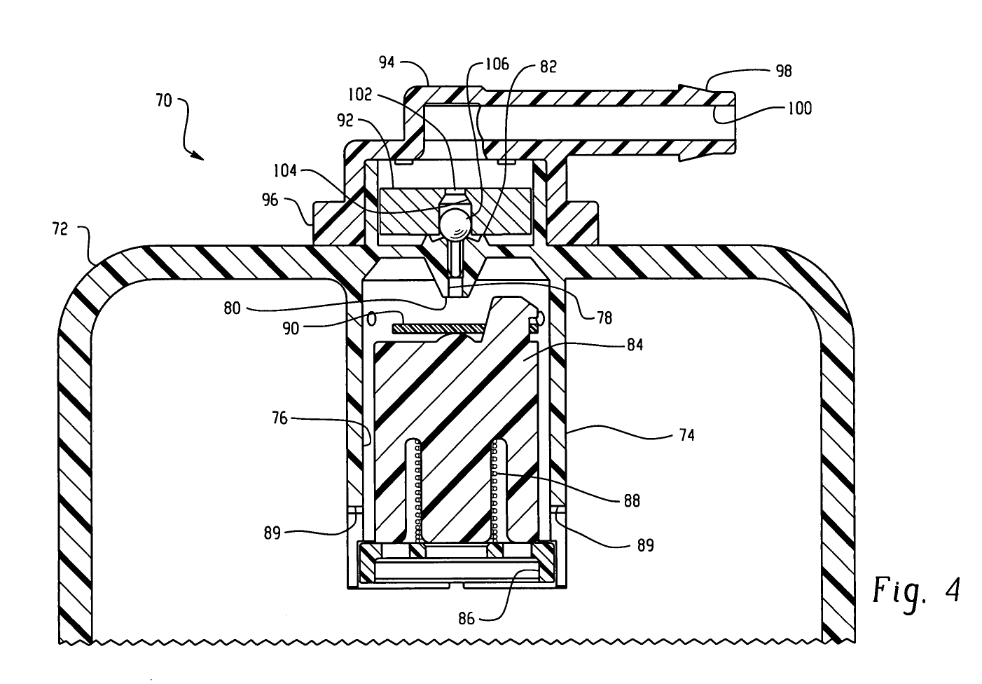

Referring to FIG. 4, another embodiment is indicated generally at 70 in which an upper portion 72 of the fuel tank wall structure has formed integrally therewith as one piece a valve body 74 which extends inwardly from the tank wall structure and defines a valving chamber 76 with a vertically oriented vent passage 78 through the wall structure of the tank. Passage 78 has a valve seat 80 formed on the lower end thereof with a second valve seat 82 formed about the upper end thereof.

Valving chamber 76 has disposed therein a float 84 which is retained by a retaining member 86 disposed in the lower end of the chamber 76; and, a bias spring 88 is disposed between the lower end of the float 84 and the retaining member 86 for biasing the float in an upward direction. As is known in the art, spring 88 may be calibrated to assist the buoyancy of the float 84.

The upper end of the float has disposed thereon a relatively thin flexible valve member 90 which may be formed of elastomeric material and which is operative upon upward movement of the float to close against valve seat 80 at the desired liquid level of fuel in the tank. The valving chamber 76 has slots 89 formed in the lower end thereof to admit liquid fuel to valving chamber 76.

A pressure relief valve member 92 is disposed over the valve seat 82 on the upper end of vent passage 78; and, the valve member 92 is urged against the valve seat 82 by the gravitational forces acting on the valve member 92 which may be formed of metal. The diameter valve seat 82 is chosen such that when a predetermined vapor pressure exists in the tank the pressure acting across the area of the valve seat is operative to produce a lifting force sufficient to overcome the rake weight of the valve member 92 lifting the valve member off of the valve seat 82 and permitting fuel vapor to escape from the tank.

A cap 94 formed of material weldable to the tank wall 72 is received over the valve member 92; and, the cap 94 has an annual flange 96 which is then joined to the tank wall by weldment, such as by hot plate, sonic or spin welding. Cap 94 includes integrally therewith a fitting 98 adapted for receiving a flexible hose thereon and which has a vapor outlet passage 100 formed therethrough which communicates with the valve seat 82.

The valve member 92 has a vertical passage 102 formed therethrough which has an inverted valve seat 104 formed therein; and,

The valve seat 104 opens into an enlarged diameter passage which has received and retained therein a valve member 106 which in the present practice has a spherical configuration. The valve member 106 is generally feather-light and formed of plastic material such that, upon the slightest positive vapor pressure in the chamber 76 and passage 78, the member 106 is moved upwardly to close against valve seat 104 and remains closed thereagainst so long as a positive vapor pressure exists in the chamber 76. Upon the occurrence of a sub atmospheric pressure in the tank, chamber 76 and vent passage 78, valve member 106 is drawn downwardly to open valve seat 104 and permit reverse flow through the passage 100. Valve member 106 thus functions as a vacuum relief valve to admit make up air as fuel is withdrawn from the tank during engine operation, or after cooling and vapor condensation during engine shut down.

The presently described low profile vapor vent/tipping valve assembly includes a pressure relief function which prevents vapor from venting from the tank until a predetermined vapor pressure is reached; and, the valve assembly also includes a vacuum relief valve to permit reverse flow and entry of make up air as fuel is withdrawn from the tank or cooling of vapor creates a vacuum therein.

Although an exemplary embodiment has been described and illustrated hereinabove, it will be understood that modifications and variations may be made by those skilled in the art within the scope of the following claims.

1. In combination a small engine fuel tank with an overfill limiting vapor vent/tipping valve assembly with pressure and vacuum relief comprising:
tank wall structure;
a vent cap with a vapor outlet port, wherein the cap is formed of a material weldable to the fuel tank;
a valve having a vapor vent passage, wherein the vent cap is received over the valve such that the vapor vent passage communicates with the vapor outlet port; and
a pressure relief valve disposed in the vapor vent passage;
wherein the vent cap is sealingly joined to the tank wall structure, and wherein the valve extends into the fuel tank.

2. The combination defined in claim 1, wherein said valve includes a pressure relief valve operable to prevent flow through the vent passage until a predetermined vapor pressure level is reached in the fuel tank.

3. The assembly defined in claim 2, wherein said pressure relief valve includes a vacuum relief valve operable to permit reverse flow through the pressure relief valve when sub-atmospheric pressure occurs in the fuel tank.

4. The combination defined in claim 3, wherein the vacuum relief valve includes a spherical valve member.

5. The combination defined in claim 1, wherein the valve includes a float operated valve.

6. The combination defined in claim 5, wherein the float operated valve includes a flexible valve member disposed on the upper surface thereof.

7. The combination defined in claim 1, wherein the pressure relief valve includes a valve member that is gravity biased to a closed position.

8. The combination defined in claim 7, wherein vacuum relief valve is disposed in the gravity biased valve member.

9. The combination defined in claim 1, wherein the valve is formed of material that is not weldable to the tank wall structure.

10. (canceled)

11. The combination defined in claim 1, wherein the vapor vent/tipping valve includes a valve body integrated with a portion of the tank wall structure.

12. A method of making a small engine fuel tank with an overfill limiting vapor vent/tipping valve assembly comprising:
forming a vent cap of material weldable to the fuel tank and forming a vapor outlet passage in the vent cap;
disposing a valve in the fuel tank;
disposing a pressure relief valve over the valve and preventing flow to the vapor outlet passage at a fuel tank vapor pressure below a predetermined pressure level; and,
positioning the vent cap over the pressure relief valve and attaching the vent cap to the wall of the fuel tank.

13. The method defined in claim 12, wherein the step of attaching the vent cap to the wall of the tank includes welding.

14. The method defined in claim 12, wherein the step of disposing a pressure relief valve includes disposing a vacuum relief valve.

15. The method defined in claim 14, wherein the step of disposing a vacuum relief valve includes disposing a moveable valve member in the pressure relief valve.

16. The method defined in claim 15, wherein the step of disposing a moveable valve member includes disposing a spherical valve member.

17. The method defined in claim 12 wherein the step of disposing a valve includes disposing a float operated valve.

18. The method defined in claim 12, wherein the step of disposing a valve includes attaching the valve to the cap to form a sub assembly before joining vent cap to the fuel tank.

19. The method defined in claim 12 wherein the step of disposing a valve includes integrating a valve body member with a portion of the tank wall structure.

20. An valve assembly for use in a small engine fuel tank, comprising:
a vent cap with a vapor outlet port, the cap being formed of material weldable to the fuel tank;
a valve having a vapor vent passage, and
a pressure relief valve disposed in the vent passage,
wherein the vent cap is configured join to the fuel tank, wherein the vent cap is disposed over the valve such that the vent passage communicates with the vapor outlet port, and wherein the valve is adapted to extend into the fuel tank.

21. The assembly of claim 20, wherein the valve includes a pressure relief valve operable to prevent flow through the vent passage until a predetermined vapor pressure level is reached in the fuel tank.

22. The assembly of claim 21, wherein the pressure relief valve includes a vacuum relief valve operable to permit reverse flow through the pressure relief valve when sub-atmospheric pressure occurs in the fuel tank.

23. The assembly of claim 22, wherein the vacuum relief valve includes a spherical valve member.

24. The assembly of claim 20, wherein the valve includes a float operated valve.

25. The assembly of claim 24, wherein the float operated valve includes a flexible valve member disposed on an upper surface of the valve.

26. The assembly of claim 20, wherein the pressure relief valve includes a valve member that is gravity-biased to a closed position.

27. The assembly of claim 20, wherein the pressure relief valve includes:
a valve member gravity biased to the closed position; and
a vacuum relief valve disposed in the gravity-biased valve member.

28. The assembly of claim 20, wherein the valve is formed of material that is not weldable to the fuel tank.
